(19) United States
(12) Patent Application Publication
(10) Pub. No.: US 2020/0047657 A1
(43) Pub. Date: Feb. 13, 2020

(54) HORSE LOADER

(71) Applicants: Patrick Todd Cluff, New River, AZ (US); Shane Smith, Chandler, AZ (US)

(72) Inventors: Patrick Todd Cluff, New River, AZ (US); Shane Smith, Chandler, AZ (US)

(21) Appl. No.: 16/537,591

(22) Filed: Aug. 11, 2019

Related U.S. Application Data
(60) Provisional application No. 62/717,856, filed on Aug. 12, 2018.

(51) Int. Cl. B60P 3/04; A01K 3/00; E04H 17/18

(52) U.S. Cl. CPC B60P 3/04; E04H 17/18; A01K 3/00

(57) ABSTRACT

Methods and apparatus are provided for a trailer-mounted system for easing the process of loading a horse into a horse trailer. In one embodiment the system includes a plurality of hinged panels pivotally attached at a proximal end thereof to a back or side of the horse trailer. The panels are moveable between a stowed condition folded one atop the other against the trailer, and a deployed condition with the panels unfolded and extended away from the trailer.

### TECHNICAL FIELD

This application claims priority to Provisional patent application No. 62/717,856, the entire contents of which are hereby incorporated by reference. The technical field of the present invention relates to livestock trailers, and more particularly to horse trailers.

### BRIEF DESCRIPTION OF THE DRAWINGS

In the accompanying drawings:

FIGS. 1 and 2 are perspective views of an embodiment of the horse loader shown in a stowed condition on a horse trailer rear door;

FIG. 3 is a side view of the horse loader embodiment shown in FIGS. 1 and 2;

FIG. 4 is a perspective close-up view of a lower portion of the horse loader and horse trailer door;

FIG. 5 is another perspective view of a lower portion of the horse loader shown in a stowed condition resting on support bracket;

FIG. 6 is a perspective view of the horse loader held in a stowed condition by a latch;

FIG. 7 is a perspective view of the horse loader embodiment of FIGS. 1 and 2 in a stowed condition with the horse trailer door open;

FIGS. 8 through 10 are top views showing the horse loader embodiment of

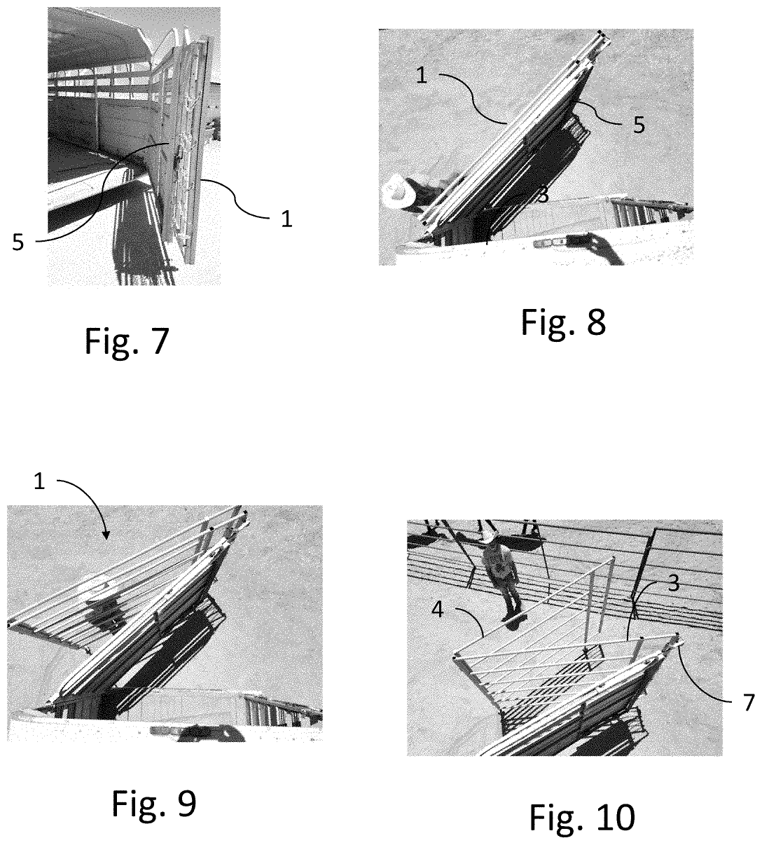

FIG. 7 being unfolded from the stowed condition;

FIG. 11 is a close-up perspective view showing a door extension portion of the horse loader;

FIGS. 12 through 14 are close up top perspective views showing exemplary embodiments of a double-pin hinge portion of the horse loader;

FIGS. 15 through 18 are perspective and top views of an open-sided enclosure formed by the horse loader in a deployed condition;

FIGS. 19 through 22 are top and perspective views showing a distal end of the horse loader pulled all the way to a corner of the trailer;

FIGS. 23 through 26 are top views showing the horse loader in various positions alongside the horse trailer;

FIGS. 27 through 29 are top, back, and side perspectives showing the horse loader panels entirely alongside the horse trailer and the trailer door closed;

FIG. 30 is a top view of an embodiment of the horse loader installed on a horse trailer with two rear doors;

FIGS. 31 and 32 are top views of the horse loader of FIG. 30 being moved from a stowed to a deployed condition;

FIGS. 33 through 37 are sequential top views showing an exemplary horse loading process with the horse loader of FIG. 30;

FIG. 38 is a top view of a door guide mechanism portion of a horse loader embodiment for use in conjunction with horse trailer having two rear doors;

FIGS. 39 through 41 are top perspective views showing the door guide mechanism of FIG. 38 in operation; and

FIG. 42 is a top view of an embodiment of the horse loader in a stowed condition on a side of a horse trailer.

### DESCRIPTION OF THE EMBODIMENTS

The instant invention is described more fully hereinafter with reference to the accompanying drawings and/or photographs, in which one or more exemplary embodiments of the invention are shown. This invention may, however, be embodied in many different forms and should not be construed as limited to the embodiments set forth herein; rather, these embodiments are provided so that this disclosure will be operative, enabling, and complete. Accordingly, the particular arrangements disclosed are meant to be illustrative only and not limiting as to the scope of the invention. Moreover, many embodiments, such as adaptations, variations, modifications, and equivalent arrangements, will be implicitly disclosed by the embodiments described herein and fall within the scope of the present invention.

Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. Where only one item is intended, the term “one”, “single”, or similar language is used. When used herein to join a list of items, the term “or” denotes at least one of the items, but does not exclude a plurality of items of the list.

For exemplary methods or processes of the invention, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present invention.

Additionally, any references to advantages, benefits, unexpected results, or operability of the present invention are not intended as an affirmation that the invention has been previously reduced to practice or that any testing has been performed. Likewise, unless stated otherwise, use of verbs in the past tense (present perfect or preterit) is not intended to indicate or imply that the invention has been previously reduced to practice or that any testing has been performed.

The inventors have recognized and discovered that existing techniques for loading horses into transport trailers are often simply inadequate with animals that, for any number of reasons, become agitated or are otherwise reluctant to enter the trailer. In such cases, an extremely agitated horse can injure itself, or others around it, in the process of resisting efforts by handlers to lead it into a trailer.

In attempting to find a better solution, the inventors further discovered that horses tend to move away from an encroaching non-human apparatus, such as a gate or fence, more reliably and with less agitation than when being led or coaxed by a human handler. The inventors further discovered that the difference is more pronounced particularly when the encroaching gate or fence is encircling the animal and making noise in the process, thus driving the animal to the perceived “safe” space inside the trailer. The inventors then deduced that this tendency of horses to respond better to a moving, encroaching, noisy apparatus could be taken advantage of to create a better way of safely encouraging horses or other livestock to move in a desired direction, such as into a transport trailer.

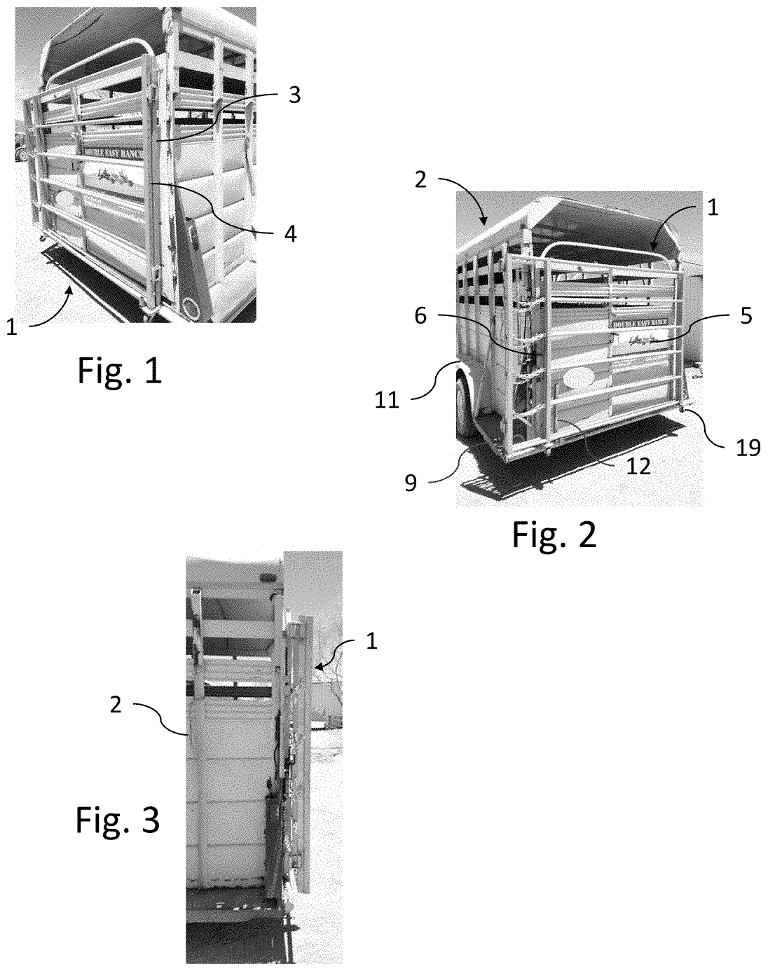

Referring now to the drawing Figures, an exemplary horse loader in accordance with the present disclosure is indicated generally at reference numeral 1 throughout. The loader 1 is essentially an arrangement of hinged panels for use in conjunction with a horse trailer 2 for easing the process of loading a horse into the trailer. In FIGS. 1 through 3, the panels are shown in a stowed condition, folded one on the other, supported on and latched to the outside of trailer door. The trailer shown has only one door, although the loader works equally well on trailers with two doors or a drop-down ramp, with certain minor differences described later herein.

In the depicted one-door trailer embodiment, the loader consists of first and second hinged together panels 3, 4, connected to the latching end 6 of the trailer door 5 with a door extension 7. The panels 3 and 4 are longer than the door is wide by at least the amount that the trailer is wider than the trailer door on one side of the trailer. This can be seen for example in FIG. 2, where panels extend out past the door and the left side of the trailer all the way to the outside edge of the skirt 9 and wheel well 11. In the depicted embodiments the panels 3, 4, are made of welded steel tubing in the manner of typical horse corral fencing, although any number of other materials and constructions may be used instead.

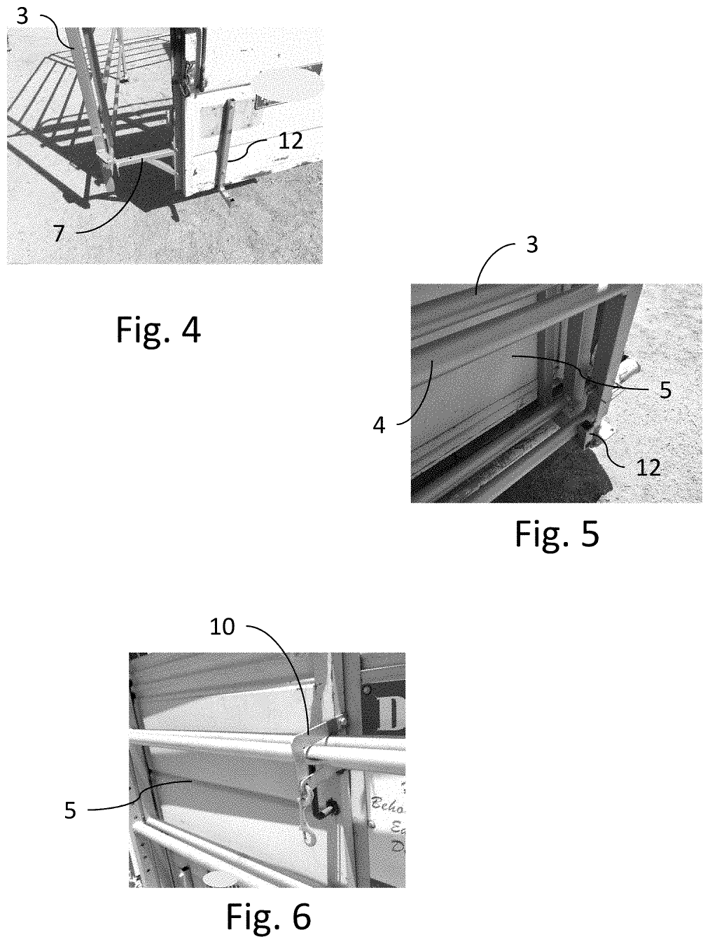

Referring to FIGS. 4 and 5, the panels 3 and 4 are supported on the trailer door 5 in the stowed position by a pair of U-brackets 12. The brackets extend out far enough to support both panels at once when folded flat against the trailer door. Referring now also to FIG. 6, the panels may be secured to the trailer door in the stowed position with a latch 10. The latch may be a gate latch type device as shown, with enough depth to simultaneously capture adjacent horizontal bar portions of the two panels 3, 4, as shown.

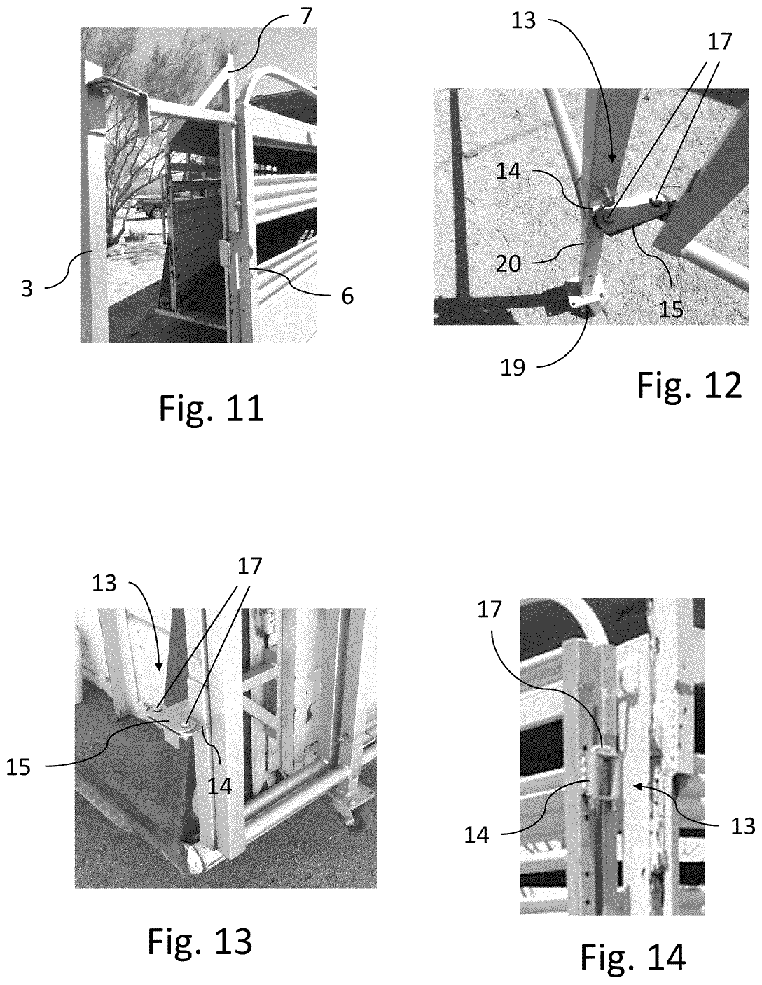

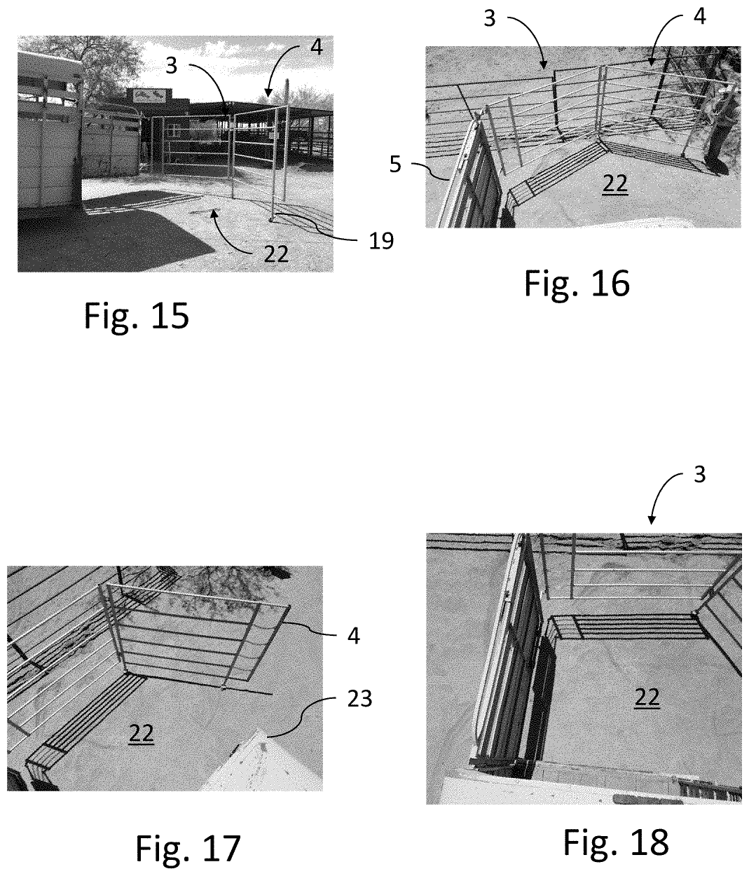

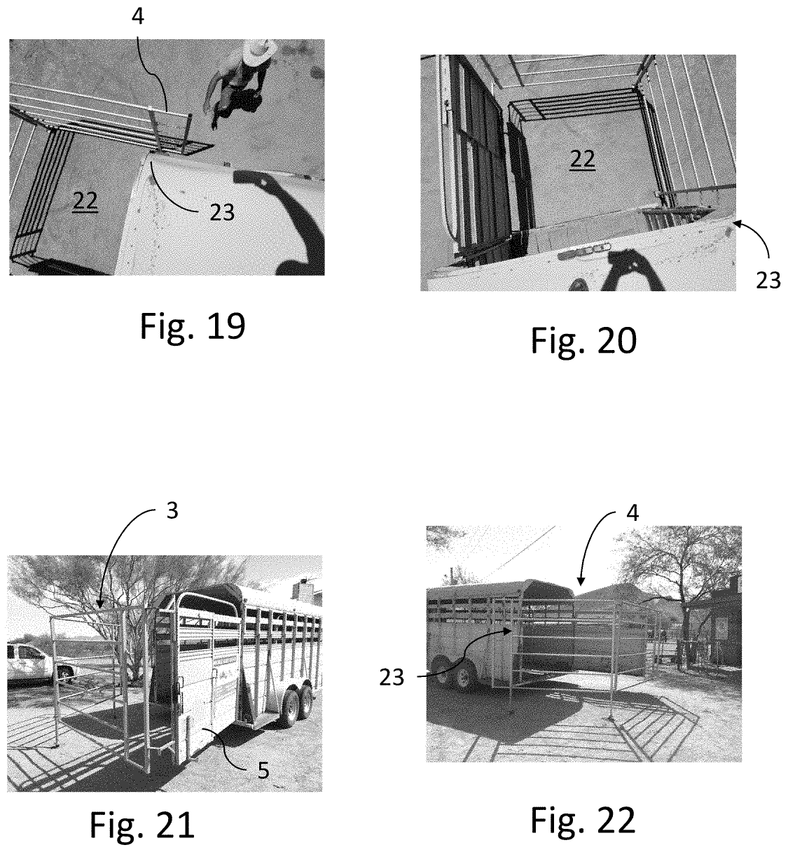

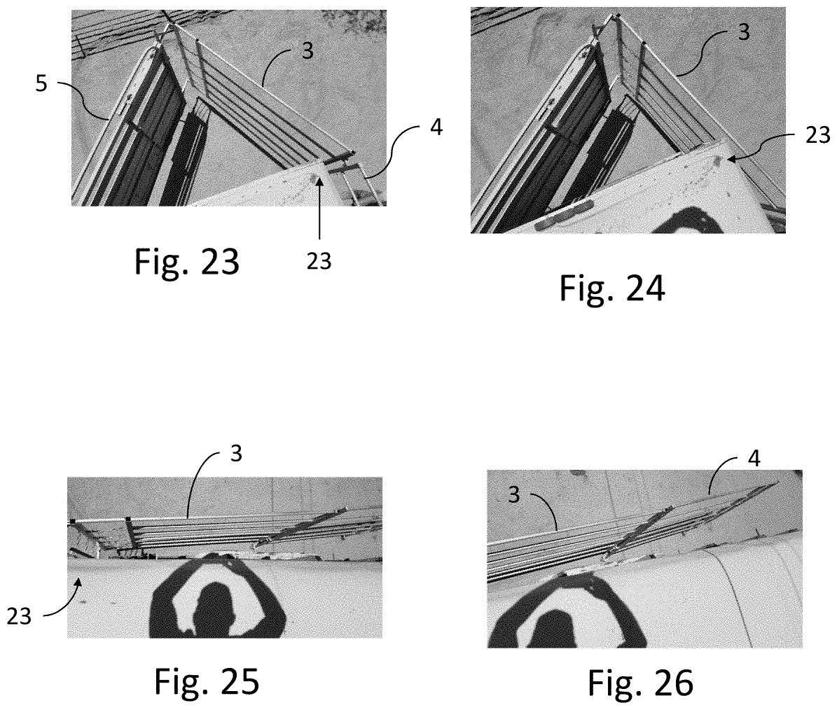

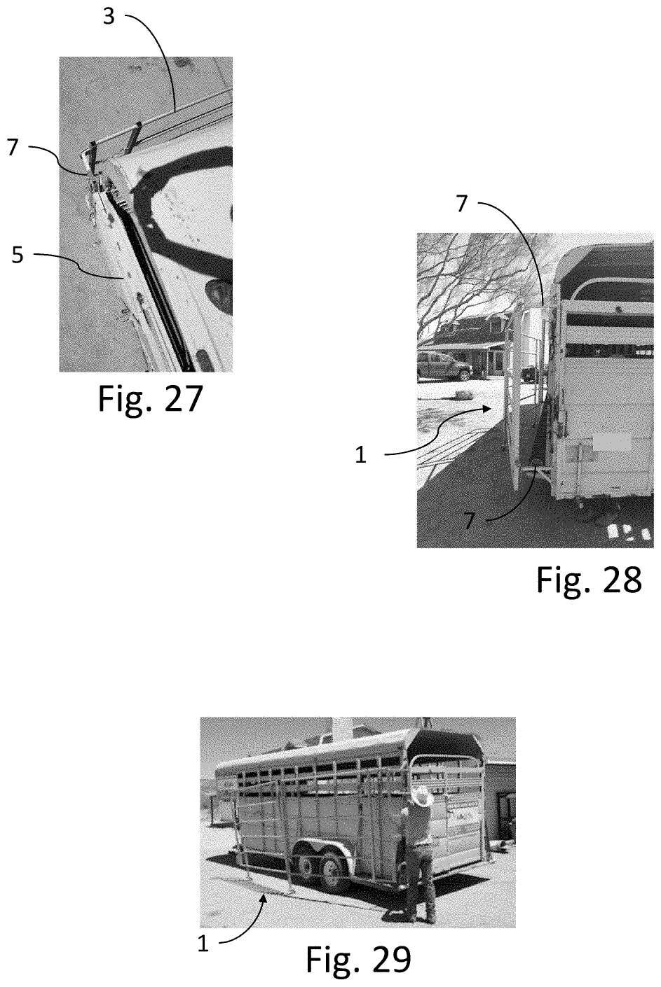

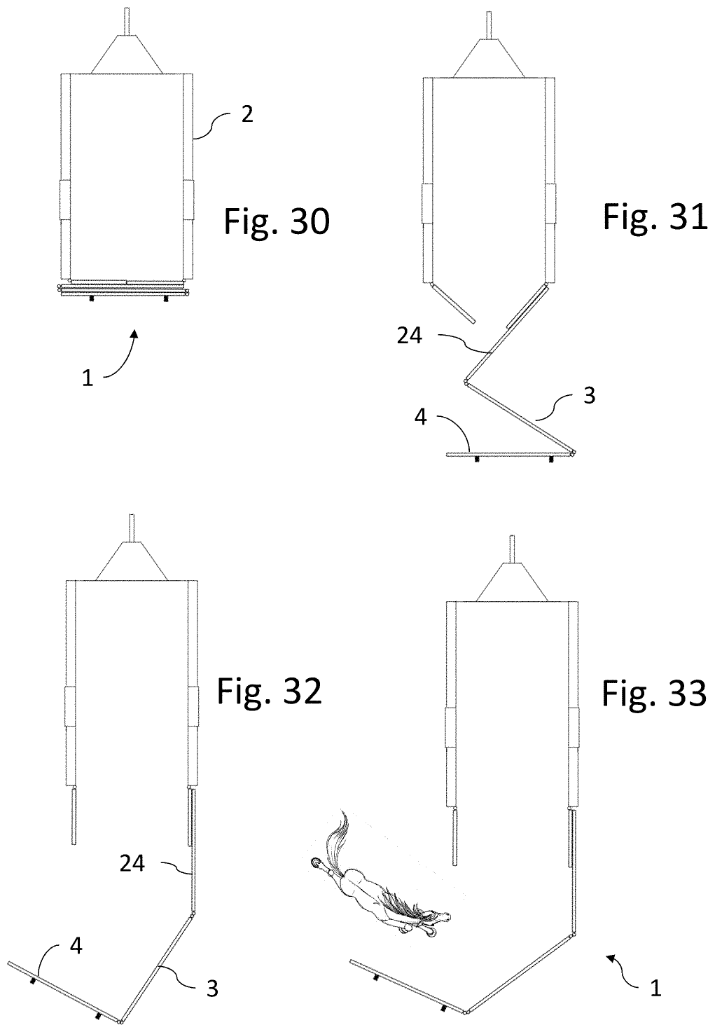

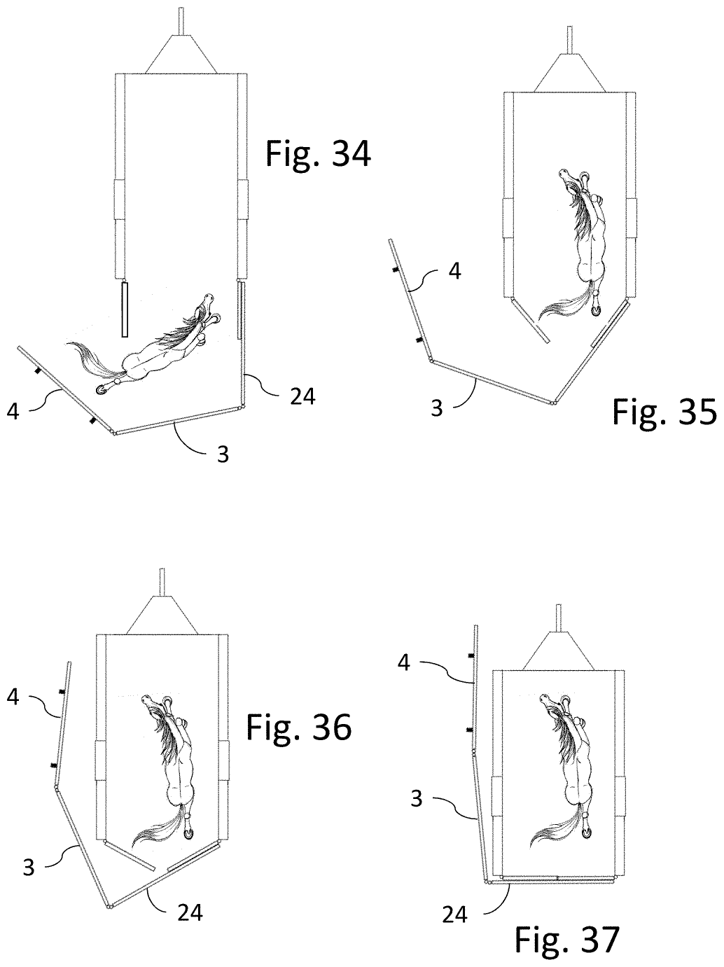

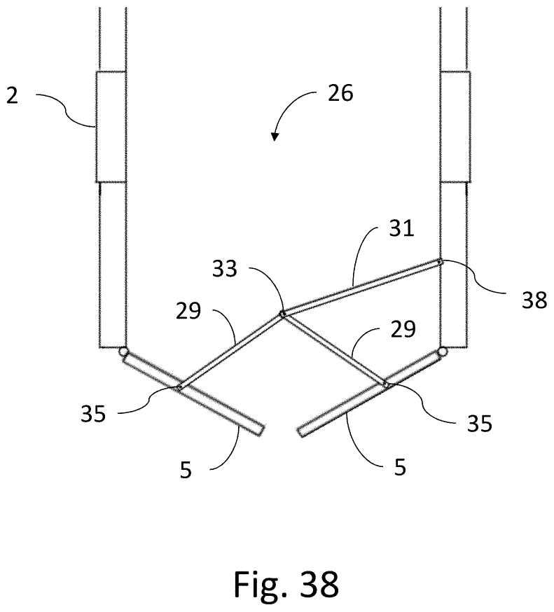

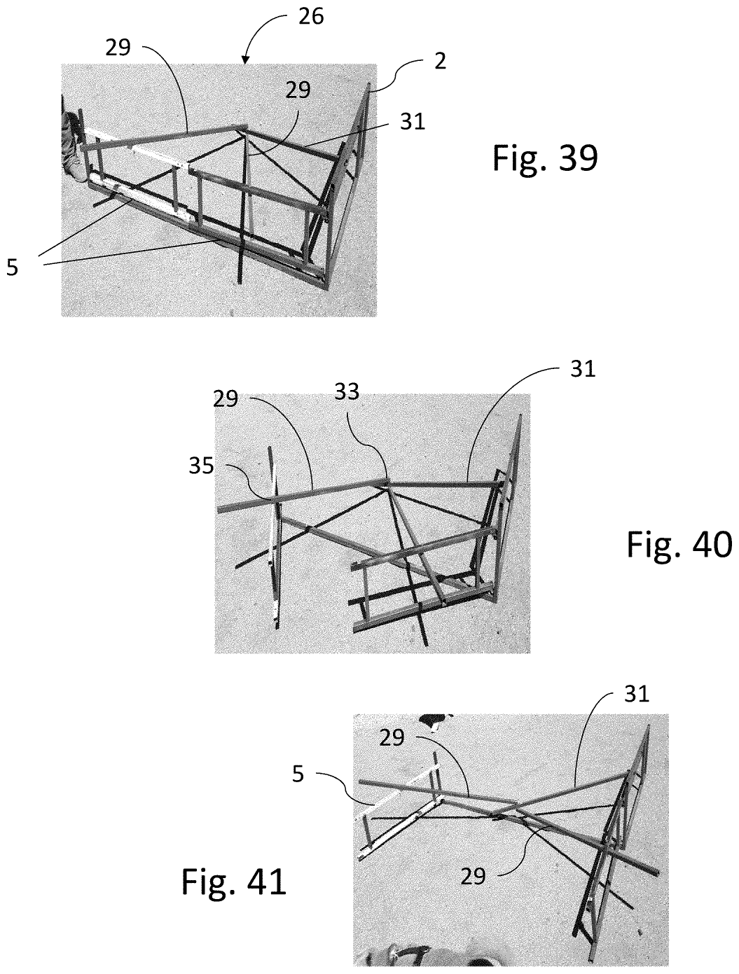

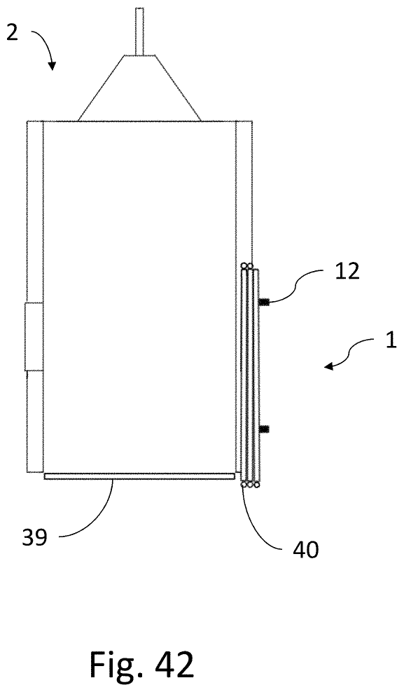

FIGS. 7 and 8 show the trailer door swung approximately halfway open with the loader still in the stowed position on the door. FIGS. 9 and 10 show the loader panels released from the door and the initial phases of unfolding and extending the panels away from the trailer toward a horse loading position. As can be seen in FIGS. 10 and 11, the first panel 3 is hinged to the extension 7 instead of directly to the edge of the door. The extension 7 effectively acts to lengthen the door so that the door and extension together are the same length as panels 3 and 4. The extension may be configured as two separate angle brackets attached at the upper and lower ends of the door as shown. The reason for the extension, as will be explained in more detail below, relates to the later stages of a horse loading process.

The loader panels are connected to each other and to extension 7 with unique double pin hinges 13 shown in FIGS. 12 through 14. A hinge leaf 14 in the form of a flat tab with a hole (FIGS. 12 and 13), or a length of tubing (FIG. 14), is permanently attached, such as by welding, to the edges of the door panels and to extensions 7. Adjacent leafs 14 are connected by a spacer 15 that pivots on both leafs with hinge pins 17. Spacer 15 may be a section of flat plate with holes at each end as shown. Each hinge has two spacers 15 with one above and one below the leafs. In the hinge embodiment shown in FIGS. 12 and 13, the leafs 14 are flat welded tabs, and the hinge pins 17 are threaded bolts passing through holes in the spacers and leafs, held on with nuts. The hinge embodiment shown in FIG. 13 uses vertical sections of steel tubing as leafs 14, and a single U-bolt serving as the hinge pins and spacer. The double pin hinges when properly configured allow the panels to be folded back-to-back as shown in FIGS. 13 and 14, preferably with a small gap between them to prevent the panels from wedging against each other when stowed on the trailer door.

The bottom of panel 4 is equipped with a pair of drop down spring-loaded casters 19 that are moveable from a raised position visible for example in FIG. 2, to a lowered position visible in FIGS. 12 and 15. Each caster may be mounted to the end of a telescoping length of tubing 20 that slides inside a vertical frame member of the panel. The casters may be placed in the raised position for transport and lowered prior to unfolding and extending the panels away from the door. In the lowered position the casters act to support panel 4 on the ground while allowing it to be moved around and maintained in a substantially level position relative to the door. The tubing 20 may be provided with a series of holes for locking the tubing to the panel frame member and adjusting the position of the casters as needed to support the panel.

FIGS. 15 and 16 show the panels 3 and 4 fully unfolded and arranged along with the door in a large open-sided enclosure 22 for horse loading. In this loading position a horse is initially led through the wide opening between the end of panel 4 and the back corner of the trailer into the enclosure. Because the enclosure is relatively large, and opening is wide, a horse will tend to enter the enclosure freely and generally unconcerned with the open trailer nearby. Once the horse is comfortably inside the enclosure, a handler holding onto the free end of panel 4 can begin to pull it generally forward and toward the (left rear as depicted) corner 23 of the trailer as shown in FIGS. 16 through 18. FIGS. 19 through 22 show the loader pulled all the way to the corner 23, completely closing the original opening that the horse entered through, and continually forcing the horse into a smaller and smaller space outside the trailer. By strategically positioning the handler generally near the end of panel 4, it appears from the horse's perspective that the panels are simply moving toward it. As the inventors deduced and intended, horses tend to react to this motion of the panels by moving away from it and keeping their distance, which requires moving increasingly closer to the open end of the trailer. The panels and casters may be also configured to cause erratic or bouncy motion, along with random noises and rattles when the panels are being pulled forward by a handler.

By continuing to pull the loader still further toward the front of the trailer, the end of panel 4 begins to move past the corner of the trailer and alongside it. In FIG. 22 the end of panel 4 is slightly past the corner of the trailer, and in FIG. 23 panel 4 has been pulled entirely alongside the left side of the trailer. Typically, at some point between the panel positions shown in FIGS. 22 and 23, the horse will voluntarily step into the trailer. The loading process proceeds by continuing to pull the end of the loader forward as shown in FIG. 24 where panel 3 is moving alongside the trailer, to the final position shown in FIGS. 25 through 29 with the entire loader alongside the trailer, and the trailer door completely closed and latched. As can be seen in FIGS. 27 and 28, the extensions 7 at the top and bottom of the trailer door give panel 3 clearance from the side of the trailer, allowing it to be pulled alongside the trailer by the single handler at the end of panel 4 without wedging and interfering with the door being pulled completely closed. The extensions should generally be long enough to extend the hinge connection to panel 3 past the any projections on the side of the trailer such as the wheel wells and any step or skirt features.

Stowing the panels is essentially the reverse of the sequence shown in FIGS. 9 and 10, where now the loader is folded back up onto the trailer or door, one panel at a time, and secured with gate latch 10. The loaded trailer is then ready for transport. Upon reaching a destination, the horse may be let out of the trailer by opening the trailer door with the loader still on the door, as shown for example in FIGS. 7 and 8. Moreover, the trailer door may be operated normally, opening and closing it as needed with the loader always remaining stowed and latched on the door.

FIGS. 30 through 37 illustrate an example of the loader adapted to a two-door horse trailer. FIGS. 30 through 32 show the loader being deployed, and FIGS. 33 through 37 show a horse loading process. As in the above described single door embodiment, the loader includes hinged panels 3 and 4, and a door extension in the form of a third panel 24 that attaches to the outside of one of the two trailer doors as shown. Panel 24 is longer than the door, extending out far enough to completely overlap the other door when the doors are closed, and past the side skirt and/or wheel well on the far side of the trailer in the same manner as the extensions 7 in the single door embodiment.

FIG. 30 shows the two-door loader folded up and stowed. Brackets such as U-brackets 12 mounted at the bottom of panel 24 in this case support panels 3 and 4 in the stowed condition. The trailer doors may be operated with the loader stowed by opening the door holding the loader first when opening the trailer doors and closing the door without the loader first when closing the doors. The latching arrangement on the doors may dictate which door the loader must be mounted on.

FIGS. 32 through 37 show the loading operation using the two-door loader. The panels are extended out away from the trailer as described previously to the open sided enclosure position shown in FIG. 32. The horse is then led into the enclosure by one handler, while preferably a second handler begins to pull the end of the loader toward the front of the trailer. As the loader continues to be pulled forward and the enclosure shrinks, the horse eventually enters the trailer as shown in FIGS. 34 and 35 while the trailer doors both progressively close behind it. When the loader is pulled all the way forward as shown in FIG. 37, both trailer doors are completely closed. The loader may then be folded back up and mounted on the back of the trailer for transport as in FIG. 30.

FIG. 38 shows a door guide mechanism 26 that can be used on a two-door trailer to cause the doors to open and close in unison. FIGS. 39 through 41 sequentially show the door guide in operation, beginning with the doors 5 closed in FIG. 39, and fully open in FIG. 41. The door guide is an arrangement of three rigid links or bars, consisting of two door bars 29 and one fixed-end bar 31. One end of each of the door bars 29 and the fixed end bar 31 are all pivotally connected together at a central pivot point 33. An opposite end of each door bar 29 is connected to the top of each door at door pivots 35 that are located roughly at the center of each door, while an opposite end of fixed end bar 31 is pivotally connected to one side of the trailer at side pivot 38.

When the doors are closed, the fixed end bar 31 extends generally perpendicularly away from the side of the trailer to the central pivot point 33 positioned roughly at the center of the trailer and aligned with the door seam. The distance of the side pivot 38 from the back of the trailer is selected to create an angle of less than 90 degrees between the two door bars 29.

Referring to FIG. 40, as the doors begin to open, the fixed end bar 31 pivots rearward, and the angle between the door bars 29 begins to open. Because the three bars are all connected at the central pivot point 33, neither door can be moved in an open or closed direction without causing the other door to move in the same open or closed direction. If everything is arranged symmetrically, the doors will also move by the same amount. Thus, both doors may be opened or closed simultaneously and in unison by manually forcing only one of the doors to move. Referring again to FIGS. 35 through 37, the two trailer doors equipped with door guide 26 could be caused to automatically close in the manner depicted by the single handler pulling at the end of the loader as the panels are brought around to the front of the trailer. The door guide may be located in the ceiling area inside the trailer, protected by an optional headliner, or on the trailer roof.

FIG. 42 shows an alternative stowed configuration where the loader is folded and mounted along one side of the trailer instead of on the back. This configuration may be used with the single or two-door embodiments described above, or also with a fold down rear trailer door that forms a ramp, such as the depicted ramp door 39 shown in FIG. 42. The loader shown has panels 3 and 4, and the third panel 24 which is hinged at top and bottom to the back corner of the trailer with short stand-offs 40. The stowed loader can be supported on U-brackets 12 as shown, or simply on top of the wheel well.

When side mounted, the loader is not attached to a trailer door, and in that sense is operated independently of the doors. For example, in the depicted embodiment with a drop-down ramp, deploying the loader starts by lowering the ramp first, and then extending the panels out behind the trailer. The horse is then loaded in the manner described above while the ramp stays down. Once the horse is in, the loader panels can be moved back away from the open end of the trailer far enough for the ramp to then be quickly lifted and closed. The loader can then be stowed on the side of the trailer.

When a side mounted arrangement is used on a hinged one or two door trailer, the loading process is essentially unaffected. Although the loader is not attached to a door, pulling the panels forward during the loading process will still cause the doors to close behind the horse, and the process can proceed exactly as described above.

There has been described a novel horse loading apparatus and process with substantially improved ability to cause a horse to enter a trailer without becoming agitated or causing harm to itself and/or the handler. For the purposes of describing and defining the present invention it is noted that the use of relative terms, such as “substantially”, “generally”, “approximately”, and the like, are utilized herein to represent an inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Exemplary embodiments of the present invention are described above. No element, act, or instruction used in this description should be construed as important, necessary, critical, or essential to the invention unless explicitly described as such. Although only a few of the exemplary embodiments have been described in detail herein, those skilled in the art will readily appreciate that many modifications are possible in these exemplary embodiments without materially departing from the novel teachings and advantages of this invention. Accordingly, all such modifications are intended to be included within the scope of this invention as defined in the appended claims.

In the claims, any means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Unless the exact language “means for” (performing a particular function or step) is recited in the claims, a construction under § 112, 6th paragraph is not intended. Additionally, it is not intended that the scope of patent protection afforded the present invention be defined by reading into any claim a limitation found herein that does not explicitly appear in the claim itself.

What is claimed is:

1. An apparatus for easing the process of loading a horse into a horse trailer, comprising:
a first elongated panel having a first end pivotally mounted to a back portion of the horse trailer; and
a second elongated panel having a first end pivotally connected to a second end of the first panel, wherein the first and second panel are moveable from a stowed condition folded one atop the other against the trailer, to a deployed condition with both panels unfolded and extended away from the trailer.

2. The apparatus of claim 1, further comprising an extendable caster for movably supporting the second elongated panel on the ground when the panels are in the deployed condition.

3. The apparatus of claim 1, wherein the first elongated panel is pivotally attached to a back door of the trailer.

4. The apparatus of claim 1, wherein the first end of the second panel is pivotally connected to second end of the first panel by at least two double-pin hinges, each double-pin hinge comprising:
a first leaf with a hole for receiving a hinge pin attached to the end of the first panel;
a second leaf with a hole for receiving a hinge pin attached to the end of the second panel and juxtaposed with the first leaf;
a spacer having a first end connected to the first leaf with a first hinge pin, and a second end connected to the second leaf with a second hinge pin.

5. The apparatus of claim 4, wherein the distance between the hinge pins is large enough to allow the second panel to be folded flat against the first panel in the stowed condition without the panels wedging against one another.

6. The apparatus of claim 5, wherein the spacer and hinge pins of each double-pin hinge comprise a single, generally U-shaped metal bar.

7. The apparatus of claim 5, wherein the first end of the first panel is pivotally attached to the trailer door by at least two double-pin hinges.

8. The apparatus of claim 3, wherein the first end of the first panel is pivotally connected to a distal end of a rigid trailer door extension that approximately aligns with a widest side portion of the trailer when the trailer door is in a closed position.

9. The apparatus of claim 8, wherein the first panel is at least as wide as a combined width of the trailer door and trailer door extension.

10. The apparatus of claim 1, further comprising a latch for securing the first and second panels to the trailer in the stowed condition.

11. The apparatus of claim 10, further comprising a support bracket attached to the trailer and configured to allow a bottom edge of the first and second panels to rest on the support bracket in the stowed condition.

12. The apparatus of claim 1, wherein the first and second panels are made of welded steel tubing.

13. A process for loading a horse into a horse trailer, comprising the steps of:
opening a rear door of the trailer;
releasing a series of hinged panels from a stowed position on a side or back of the trailer;
extending the panels away from the back of the trailer to form a curved enclosure with an opening between a distal end of the hinged panels and the trailer;
leading a horse through the opening into the enclosure;
pulling the distal end of the hinged panels forward to close the opening and shrink the enclosure until the horse is caused to enter the trailer; and
closing the rear door of the trailer.

14. The process of claim 13, wherein the hinged panels are folded one atop the other in the stowed position.

15. The process of claim 14, wherein the hinged panels are pivotally connected to the rear door of the trailer.

16. The process of claim 15, wherein the step of pulling the distal end of the hinged panels forward to close the opening simultaneously causes the trailer door to close.

17. The process of claim 15, wherein the trailer has two rear doors interconnected by a linkage that forces the doors open and close in unison.

18. The process of claim 13, wherein the doors are mounted on the trailer door in the stowed position.

19. The process of claim 13, further comprising the step of returning the hinged panels to the stowed position after the trailer door is closed.

20. A trailer-mounted system for easing the process of loading a horse into a horse trailer, comprising:
a plurality of hinged panels pivotally attached at a proximal end thereof to a back or side of the horse trailer, the panels moveable between a stowed condition folded one atop the other against the trailer, and a deployed condition with the panels unfolded and extended away from the trailer.

21. The trailer-mounted system of claim 20, wherein the proximal end of the panels is pivotally attached to a rear door of the trailer.

22. The trailer mounted system of claim 21, wherein the proximal end of the panels is pivotally connected to a distal end of a rigid trailer door extension that approximately aligns with a widest side portion of the trailer when the trailer door is in a closed position.
